(19) United States
(12) Patent Application Publication
(10) Pub. No.: US 2024/0339585 A1
(43) Pub. Date: Oct. 10, 2024

(54) METHOD OF MANUFACTURING ELECTRODE FOR LITHIUM SECONDARY BATTERY

(71) Applicants: Hyundai Motor Company, Seoul (KR); Kia Corporation, Seoul (KR)

(72) Inventors: Dong Hyeop Han, Seoul (KR); Byung Yong Lee, Anyang (KR); Hyun Jeong Kim, Suwon (KR)

(21) Appl. No.: 18/530,752

(22) Filed: Dec. 6, 2023

(30) Foreign Application Priority Data
Apr. 6, 2023 (KR) 10-2023-0045489

(51) Int. Cl. H01M 4/04; H01M 4/62

(52) U.S. Cl. CPC H01M 4/0435; H01M 4/623; H01M 2300/0068

(57) ABSTRACT

Disclosed is a method of manufacturing an electrode for a lithium secondary battery in a dry manner.

### CROSS-REFERENCE TO RELATED APPLICATION

This application claims, under 35 U.S.C. § 119 (a), the benefit of priority from Korean Patent Application No. 10-2023-0045489, filed on Apr. 6, 2023, the entire contents of which are incorporated herein by reference.

### TECHNICAL FIELD

The present disclosure relates to a novel method of manufacturing an electrode for a lithium secondary battery in a dry manner.

### BACKGROUND

In the related art, electrodes for lithium secondary batteries have been manufactured in a wet manner, e.g., by using a slurry including an active material and applying it onto a current collector or the like, and then drying the slurry.

Recently, there is a trend of making electrodes thicker to increase the energy density of lithium secondary batteries, but it is difficult to form thick electrodes in a wet manner. A wet process may be problematic in that drying becomes difficult with an increase in electrode thickness, and a binder is excessively precipitated on the surface of the electrodes due to a lifting phenomenon of the binder dissolved in a solvent.

Moreover, a polar solvent is necessarily used to exhibit adhesion and solubility of the binder, but an all-solid-state battery including a sulfide-based solid electrolyte is problematic in that the sulfide-based solid electrolyte is vulnerable to polar solvents. Furthermore, contact between solid particles such as an active material, a solid electrolyte, a conductive material, and the like is particularly important for efficient electrochemical reaction in the all-solid-state battery. However, when electrodes are manufactured in a wet manner, the binder covers the surface of the solid particles, preventing contact between the solid particles.

### SUMMARY

In preferred aspects, provided is a method of manufacturing an electrode for a lithium secondary battery in a dry manner.

The term “dry manner” as used herein refers to a process that does not include using a liquid or water (including moisture) or that includes substantially less amount of a liquid or water (including moisture). In certain aspect, the dry manner process is in contrary to a process of “wet manner” that includes using a composition (e.g., slurry) that requires liquid or water (including moisture). In an aspect, provided is a method of manufacturing an electrode for a lithium secondary battery. The method include preparing a starting material including an active material, obtaining an admixture by performing a first dry-mixing the starting material, cooling the admixture, obtaining an intermediate material by adding a binder to a cooled admixture and performing a second dry mixing, and obtaining an electrode by rolling the intermediate material with a pair of rollers.

The starting material may further include a sulfide-based solid electrolyte.

The starting material may further include a conductive material.

The admixture may be obtained by placing the starting material in a stirrer with a blade and performing the first dry-mixing the starting material at a blade line speed of about 5 m/s to 30 m/s for about 10 to 60 minutes.

The admixture may be cooled to a temperature of about 30° C. or less.

The binder may include one or more selected from the group consisting of polytetrafluoroethylene, polyethylene oxide, polyacrylic acid, and polyvinylidene fluoride.

The intermediate material may be obtained by performing the second dry-mixing the binder and the cooled admixture at a temperature less than 30° C.

Alternatively, the intermediate material may be obtained by placing the binder and the cooled admixture in a stirrer with a blade and performing the second dry-mixing for about 5 minutes to 10 minutes at a blade line speed of about 2 m/s to 10 m/s.

The electrode may be obtained by obtaining a sheet by rolling the intermediate material with a pair of first rollers and obtaining an electrode by rolling the sheet with a pair of second rollers.

The pair of first rollers may have the same rotational speed ratio.

A nip gap of the pair of first rollers may be about 200 μm to 800 μm.

The sheet may be obtained by rolling the intermediate material 1 to 3 times with the pair of first rollers.

The sheet may be a self-standing membrane.

The binder may be fiberized by applying shear force to the sheet when the sheet is rolled with the pair of second rollers.

The pair of second rollers may have a rotational speed ratio of about 1:3 to 1:10.

A nip gap of the pair of second rollers may be about 50 μm to 200 μm.

The electrode may be obtained by rolling the sheet 1 to 10 times with the pair of second rollers.

The electrode may be a self-standing membrane.

In an aspect, provided is a lithium secondary battery including an electrode that may be manufactured by the methods as described herein.

Further provided is a vehicle including the lithium secondary battery described herein.

Other aspects of the invention are disclosed infra.

### BRIEF DESCRIPTION OF THE DRAWINGS

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1 shows an exemplary lithium secondary battery according to an exemplary embodiment of the present disclosure;

FIG. 2 shows an exemplary process of manufacturing an exemplary electrode for a lithium secondary battery according to an exemplary embodiment of the present disclosure;

FIG. 3 shows an exemplary process for obtaining a sheet according to an exemplary embodiment of the present disclosure;

FIG. 4 shows an exemplary pair of first rollers according to an exemplary embodiment of the present disclosure;

FIG. 5 shows an exemplary process for obtaining an electrode by rolling the sheet according to an exemplary embodiment of the present disclosure;

FIG. 6 shows an exemplary pair of second rollers according to an exemplary embodiment of the present disclosure; and

FIG. 7 shows the rotor power of a stirrer and temperature measured in each step in Examples.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first,” “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

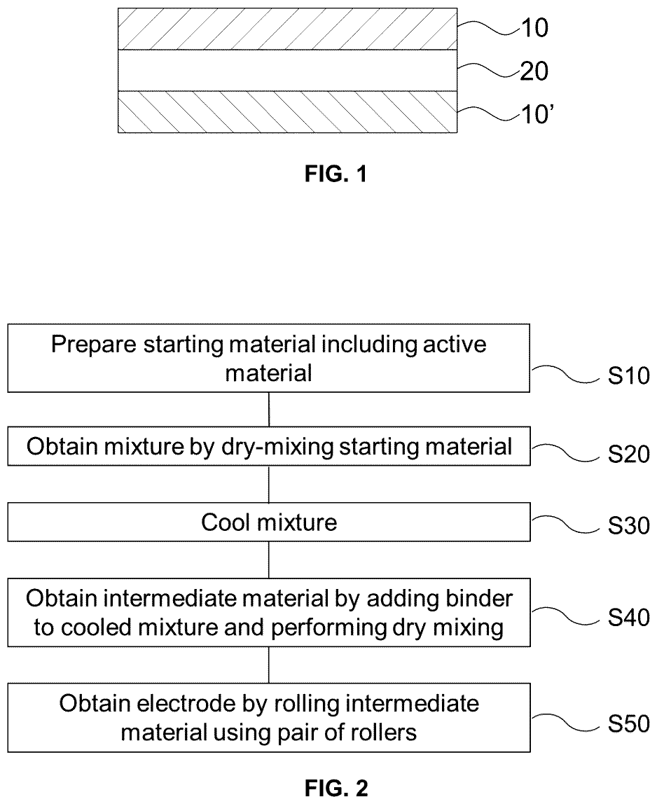

FIG. 1 shows an exemplary lithium secondary battery according to an exemplary embodiment of the present disclosure. The lithium secondary battery may include a lithium ion battery including a liquid electrolyte or an all-solid-state battery including a solid electrolyte. The lithium secondary battery may include a pair of electrodes 10, 10′ and a separator or solid electrolyte layer 20 interposed between the pair of electrodes 10, 10′.

The pair of electrodes 10, 10′ may have different polarities. When one electrode 10 is a cathode, the remaining electrode 10′ is an anode, or when one electrode 10 is an anode, the remaining electrode 10′ may be a cathode.

The electrode 10 may include an active material. When the electrode 10 is a cathode, a cathode active material may be included, and when the electrode 10 is an anode, an anode active material may be included.

The cathode active material may include a rock-salt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (M being at least one selected from among Al, Mg, Co, Fe, Ni, and Zn, 0<x+y<2), lithium titanate such as Li₄Ti₅O₁₂, and the like.

The anode active material may include a carbon active material, a metal active material, or a complex thereof.

The carbon active material may include graphite such as mesocarbon microbeads, highly oriented graphite, etc., and/or amorphous carbon such as hard carbon, soft carbon, etc.

The metal active material may include In, Al, Si, Sn, or an alloy containing at least one thereof.

The loading amount of the electrode 10 may be in an amount of about 25 mg/cm² to 35 mg/cm². Here, the loading amount may indicate the amount of the active material per unit area of the electrode 10. Recently, in order to manufacture a lithium secondary battery having high energy density, high power, and high discharge voltage, a high-capacity electrode design is required. Although attempts have been made to increase the loading amount to design a high-capacity electrode, it is preferable to adjust the loading amount to an appropriate level because the high-loading electrode design involves various problems such as overvoltage, increased resistance, etc.

The electrode 10 may optionally further include a solid electrolyte, a conductive material, a dispersant, and the like.

The solid electrolyte may include a sulfide-based solid electrolyte, an oxide-based solid electrolyte, and the like.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers and Z is any one selected from among Ge, Zn, and Ga), Li₂S—GeS₂, Li₂S—SiS₂—Li₃PO₄, Li₂S—SiS₂-LiₓMO_{y} (in which x and y are positive numbers and M is any one selected from among P, Si, Ge, B, Al, Ga, and In), Li₁₀GeP₂S₁₂, and the like.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), and the like.

The conductive material may include a particulate conductive material such as carbon black, graphene, etc., and/or a fibrous conductive material such as carbon fibers, carbon nanotubes, vapor grown carbon fibers (VGCF), etc.

The electrode 10 may include a binder. The binder may include one or more selected from the group consisting of polytetrafluoroethylene (PTFE), polyethylene oxide, polyacrylic acid, and polyvinylidene fluoride. Preferably, the binder includes polytetrafluoroethylene (PTFE).

The binder may include a fibrous binder. The fibrous binder may adhere solid particles such as an active material, a solid electrolyte, a conductive material, etc., but the area covering the surface of the solid particles is very small, and thus the lithium ion conduction path and/or electron conduction path in the electrode 10 may be efficiently formed.

The fibrous binder may be formed by applying shear force to polytetrafluoroethylene (PTFE).

Polytetrafluoroethylene (PTFE) is a polymer in which all hydrogens of polyethylene (PE) are substituted with fluorines. Although polytetrafluoroethylene (PTFE) is a polymer having an aliphatic backbone, it is widely applied in the field of electronic materials due to excellent thermal stability and electrical stability thereof. In particular, this polymer may be mainly used for a cathode due to low HOMO (highest occupied molecular orbital) level and high oxidation stability thereof. Since polytetrafluoroethylene (PTFE) has a cylindrical structure, it has a high glass transition temperature (Tg) but fiberization is possible even at a low temperature.

Polytetrafluoroethylene (PTFE) may have a specific gravity of about 2.185 or less. The lower limit of the specific gravity is not particularly limited, and may be, for example, about 2 or greater. The specific gravity is used to determine the relative molecular mass of polytetrafluoroethylene (PTFE). The specific gravity may be determined according to the procedure described in ASTM D4895. In order to perform testing, a specimen may be subjected to sintering and cooling cycles based on an appropriate sintering schedule as described in ASTM D4895. The specific gravity of polytetrafluoroethylene (PTFE) is inversely proportional to the molecular weight thereof. When the specific gravity of polytetrafluoroethylene (PTFE) is about 2.185 or less, the molecular weight of polytetrafluoroethylene (PTFE) may be sufficiently high and thus fiberization may occur well.

The fibrous binder may have a diameter of about 0.01 μm to 10 μm. Here, the diameter indicates the diameter of the cross section of the fibrous binder. The cross section refers to a cross section obtained by cutting the fibrous binder in a direction perpendicular to the length direction thereof. When the diameter thereof is less than about 0.01 μm, mechanical properties of the electrode 10 may not be sufficient, whereas when the diameter thereof is greater than about 10 μm, lithium ion conductivity and electron conductivity of the electrode 10 may decrease.

FIG. 2 shows a process of manufacturing the electrode 10, 10′ for a lithium secondary battery according to the present disclosure. The manufacturing method may include preparing a starting material including an active material (S10), obtaining an admixture by a first dry-mixing the starting material (S20), cooling the admixture (S30), and obtaining an intermediate material by adding a binder to a cooled admixture and performing a second dry mixing (S40), and obtaining an electrode by rolling the intermediate material with a pair of rollers (S50).

The starting material may optionally further include a sulfide-based solid electrolyte, a conductive material, and the like. Since the types of the sulfide-based solid electrolyte and conductive material are as described above, they are omitted below.

In particular, the components of the electrode other than the binder are primarily mixed to increase dispersibility thereof, after which the resulting admixture may be mixed with the binder, and the binder may be fiberized.

In obtaining the admixture (S20), the starting material may be placed in a stirrer with a blade, and the starting material is primarily dry-mixed for about 10 minutes to 60 minutes at a blade line speed of about 5 m/s to 30 m/s. The blade may refer to a stirring wing mounted on the stirrer. When the blade line speed is less than about 5 m/s or the mixing time is less than about 10 minutes, the starting material may not be uniformly mixed. On the other hand, when the blade line speed is greater than about 30 m/s or the mixing time exceeds 60 minutes, the active material may be pulverized and the particle size of the active material may be reduced.

Thereafter, the admixture may be cooled to a temperature of about 30° C. or less (S30). Preferably, polytetrafluoroethylene, may be a binder to be added to the admixture. Polytetrafluoroethylene starts transition in which alignment of the polymer chain is released at a temperature of about 19° C., and the transition intensifies at a temperature greater than about 30° C. Accordingly, when polytetrafluoroethylene is added to and mixed with the admixture at a temperature greater than about 30° C., fiberization of polytetrafluoroethylene proceeds excessively, remarkably deteriorating dispersibility of the result and making it impossible to control the loading amount of the electrode.

A process of cooling the admixture is not particularly limited. For example, the admixture may be allowed to stand at room temperature in a dry room or the temperature may be lowered using a cooler.

The lower limit of the cooling temperature of the admixture is not particularly limited. For example, the admixture may be cooled to a temperature of about 0° C., about 5° C., about 10° C., or about 15° C. or greater.

An intermediate material may be obtained by adding the binder to the admixture thus cooled and performing dry mixing (S40). The binder may include polytetrafluoroethylene capable of fiberization.

Obtaining the intermediate material (S40) may include dry-mixing the result of adding the binder at a temperature less than about 30° C. As described above, when polytetrafluoroethylene is stirred at a temperature of about 30° C. or greater, excessive fiberization may occur.

In obtaining the intermediate material (S40), the result of adding the binder may be placed in a stirrer with a blade, and the result may be secondarily dry-mixed for about 5 minutes to 10 minutes at a blade line speed of about 2 m/s to 10 m/s. When the blade line speed is greater than about 10 m/s or the mixing time is greater than about 10 minutes, excessive fiberization of the binder may result in poor dispersibility of the intermediate material, making it difficult to control the loading amount during electrode formation.

Thereafter, an electrode may be obtained in the form of a self-standing membrane by rolling the intermediate material with a pair of rollers (S50). Here, the self-standing membrane may mean that the electrode is capable of maintaining the shape thereof by itself without other components supporting the electrode.

Obtaining the electrode (S50) may include obtaining a sheet by rolling the intermediate material and obtaining an electrode by rolling the sheet.

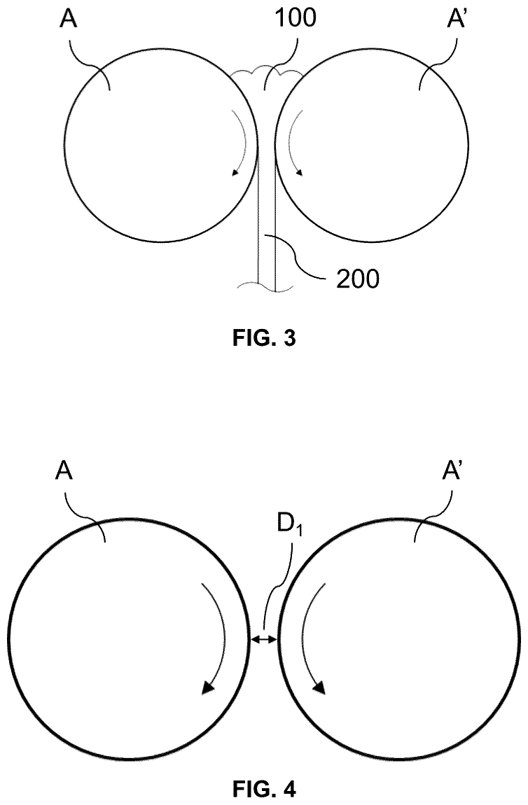

FIG. 3 shows obtaining the sheet. With reference thereto, the sheet 200 may be obtained in the form of a self-standing membrane by rolling the intermediate material 100 with a pair of first rollers A, A′.

FIG. 4 shows the pair of first rollers A, A′. The pair of first rollers A, A′ may rotate in opposite directions.

The pair of first rollers A, A′ may have the same rotational speed ratio. Here, the rotational speed ratio may mean a ratio between the rotational speed of one roller A and the rotational speed of another roller A′. When the rotational speed ratios of the pair of first rollers A, A′ are different from each other, shear force is directly applied to the intermediate material, resulting in many voids in an electrode, which is a final product, undesirably deteriorating performance of a lithium secondary battery.

A nip gap D₁ of the pair of first rollers A, A′ may be about 200 μm to 800 μm. Here, the nip gap D₁ may mean a distance between the pair of first rollers A, A′. When the nip gap D₁ is less than about 200 μm, the sheet 200 may be broken.

The sheet 200 may be obtained by rolling the intermediate material 100 1 to 3 times with the pair of first rollers A, A′. For example, assuming that the intermediate material 100 is rolled 2 times, the result obtained by feeding the intermediate material 100 into the pair of first rollers A, A′ is fed again into the pair of first rollers A, A′ and rolled, thereby obtaining the sheet 200. When the number of repetitions is greater than 3, excessive line pressure may be applied to the intermediate material 100 in a state in which no shear force is applied to the binder, so that the sheet 200 may be hardened, ultimately breaking the sheet 200.

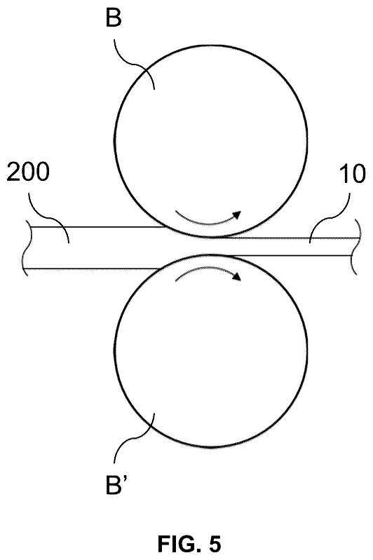

FIG. 5 shows an exemplary process of obtaining an electrode by rolling the sheet. With reference thereto, the electrode 10 may be obtained in the form of a self-standing membrane by rolling the sheet 200 with a pair of second rollers B, B′.

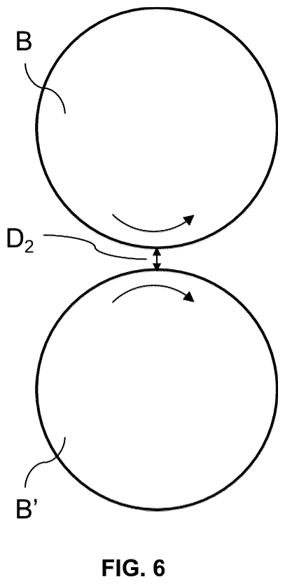

FIG. 6 shows an exemplary pair of second rollers B, B′. The pair of second rollers B, B′ may rotate in opposite directions.

The pair of second rollers B, B′ may have a rotational speed ratio of about 1:3 to 1:10. Since the rotational speed ratios of the pair of second rollers B, B′ are different from each other, shear force may be applied to the sheet, and accordingly, the binder may be fiberized. When the rotational speed ratio is less than 1:3, shear force applied to the sheet may be insufficient, so that fiberization of the binder may not occur properly. On the other hand, when the rotational speed ratio exceeds 1:10, the electrode 10 may be broken.

A nip gap D₂ of the pair of second rollers B, B′ may be about 50 μm to 200 μm. Here, the nip gap D₂ may mean a distance between the pair of second rollers B, B′. When the nip gap D₂ is less than about 50 μm, the electrode 10 may be broken. On the other hand, when the nip gap D₂ is greater than about 200 μm, the loading amount of the electrode 10 may be excessively high.

The electrode 10 may be obtained by rolling the sheet 200 1 to 10 times with the pair of second rollers B, B′. For example, assuming that the sheet 200 is rolled 2 times, the result obtained by feeding the sheet 200 into the pair of second rollers B, B′ is fed again into the pair of second rollers B, B′ and rolled, thereby obtaining the electrode 10. When the number of repetitions exceeds 10, additional rolling is unnecessary because there is no change through rolling.

### EXAMPLE

A better understanding of the present disclosure may be obtained through the following examples. These examples are merely set forth to illustrate the present disclosure, and are not to be construed as limiting the scope of the present disclosure.

### Example

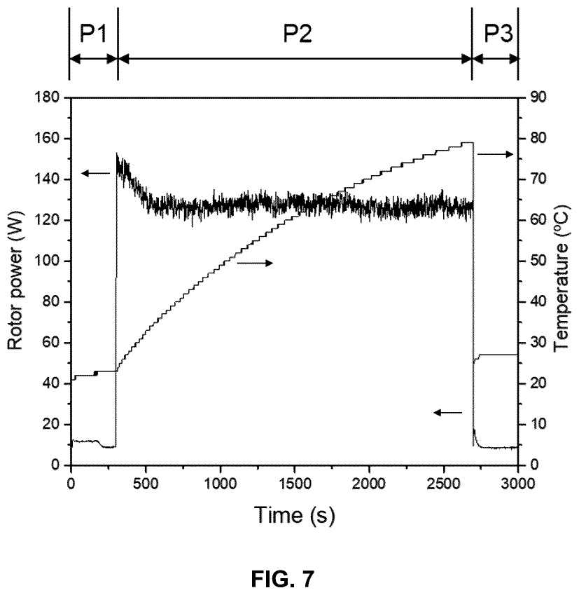

FIG. 7 shows the rotor power of a stirrer and temperature measured in each step of Example. Below is a description of each step of Example with reference to FIG. 7.

An admixture was obtained by dry-mixing a starting material including an active material, a sulfide-based solid electrolyte, and a conductive material without a solvent. For example, the starting material was placed in a stirrer with a blade and primarily dry-mixed under conditions of a blade line speed of 5 m/s and 5 minutes (P1 in FIG. 7). Thereafter, the starting material was primarily dry-mixed for 40 minutes at a blade line speed increased to 20 m/s to obtain an admixture (P2 in FIG. 7). As such, the temperature of the starting material gradually increased to a temperature of about 80° C. Here, in the case in which polytetrafluoroethylene was added together to the starting material, the polytetrafluoroethylene was excessively fiberized, remarkably decreasing dispersibility of the admixture.

After completion of mixing of the starting material, the starting material was cooled to room temperature. Polytetrafluoroethylene was added as a binder to a cooled admixture, and second dry mixing was performed under conditions of a blade line speed of 5 m/s and 5 minutes to obtain an intermediate material (P3 in FIG. 7). Here, the temperature was set to a temperature less than 30° C. so as to prevent fiberization of polytetrafluoroethylene.

A sheet was obtained by rolling the intermediate material once with a pair of first rollers at the same rotational speed ratio with a nip gap of about 300 μm. An electrode was manufactured by rolling the sheet four times with a pair of second rollers at a rotational speed ratio of 1:10 with a nip gap of about 50 μm.

The loading amount of the electrode was about 25 mg/cm², indicating that an electrode having an appropriate loading amount may be obtained using the method according to exemplary embodiments of the present disclosure.

### Comparative Example 1

An active material, a sulfide-based solid electrolyte, a conductive material, and polytetrafluoroethylene were prepared in the same amounts as in Example. The above materials were placed in the same stirrer as in Example and primarily dry-mixed under conditions of a blade line speed of 5 m/s and 5 minutes, followed by dry mixing for 40 minutes at a blade line speed increased to 20 m/s to obtain an admixture.

Shear force was applied to the admixture to obtain an intermediate material in the form of clay. For example, an intermediate material was prepared by applying shear force to the admixture until the diameter of the fibrous binder was about 0.01 μm to 10 μm through fiberization of polyetrafluoroethylene.

An electrode was manufactured by rolling the intermediate material once with a pair of first rollers at the same rotational speed ratio with a nip gap of about 300 μm. The electrode according to Comparative Example 1 was broken upon rolling with the pair of first rollers.

### Comparative Example 2

An electrode was manufactured by rolling the same intermediate material as in Comparative Example 1 four times with a pair of second rollers at a rotational speed ratio of 1:10 with a nip gap of about 50 μm. The loading amount of the electrode according to Comparative Example 2 was about 45 mg/cm², which was regarded as too high.

According to various exemplary embodiments of the present disclosure, a novel method of manufacturing an electrode for a lithium secondary battery in a dry manner can be provided.

The effects of the present disclosure are not limited to the above-mentioned effects. It should be understood that the effects of the present disclosure include all effects that can be inferred from the description of the present disclosure.

As the embodiments of the present disclosure have been described in detail above, the scope of the present disclosure is not limited to the above-described embodiments, and various modifications and improvements made by those skilled in the art using the basic concept of the present disclosure defined in the following claims are also included in the scope of the present disclosure.

What is claimed is:

1. A method of manufacturing an electrode for a lithium secondary battery, comprising:
preparing a starting material comprising an active material;
obtaining an admixture by performing a first dry-mixing the starting material;
cooling the admixture;
obtaining an intermediate material by adding a binder to a cooled admixture and performing a second dry mixing; and
obtaining an electrode by rolling the intermediate material with a pair of rollers.

2. The method of claim 1, wherein the starting material further comprises a sulfide-based solid electrolyte.

3. The method of claim 1, wherein the starting material further comprises a conductive material.

4. The method of claim 1, wherein the admixture is obtained by placing the starting material in a stirrer with a blade and performing the first dry-mixing the starting material for about 10 minutes to 60 minutes at a blade line speed of about 5 m/s to 30 m/s.

5. The method of claim 1, wherein the admixture is cooled at a temperature of about 30° C. or less.

6. The method of claim 1, wherein the binder comprises one or more selected from the group consisting of polytetrafluoroethylene, carboxymethyl cellulose, polyethylene oxide, polyacrylic acid, and polyvinylidene fluoride.

7. The method of claim 1, wherein the intermediate material is obtained by performing the second dry-mixing the binder and the cooled admixture at a temperature less than 30° C.

8. The method of claim 1, wherein the intermediate material is obtained by placing the binder and the cooled admixture in a stirrer with a blade and dry-mixing the result for about 5 minutes to 10 minutes at a blade line speed of about 2 m/s to 10 m/s.

9. The method of claim 1, wherein the electrode is obtained by steps comprising:
obtaining a sheet by rolling the intermediate material with a pair of first rollers; and
obtaining an electrode by rolling the sheet with a pair of second rollers.

10. The method of claim 9, wherein the pair of first rollers has a same rotational speed ratio.

11. The method of claim 9, wherein a nip gap of the pair of first rollers is about 200 μm to 800 μm.

12. The method of claim 9, wherein the sheet is obtained by rolling the intermediate material 1 to 3 times with the pair of first rollers.

13. The method of claim 9, wherein the sheet is a self-standing membrane.

14. The method of claim 9, wherein the binder is fiberized by applying shear force to the sheet when the sheet is rolled with the pair of second rollers.

15. The method of claim 9, wherein the pair of second rollers has a rotational speed ratio of 1:3 to 1:10.

16. The method of claim 9, wherein a nip gap of the pair of second rollers is about 50 μm to 200 μm.

17. The method of claim 9, wherein the electrode is obtained by rolling the sheet 1 to 10 times with the pair of second rollers.

18. The method of claim 1, wherein the electrode is a self-standing membrane.

19. A lithium secondary battery comprising an electrode manufactured by a method of claim 1.

20. A vehicle comprising a lithium secondary battery of claim 19.
